(19) United States
(12) Patent Application Publication
(10) Pub. No.: US 2022/0058468 A1
(43) Pub. Date: Feb. 24, 2022

(54) Field Programmable Neural Array

(71) Applicant: U.S. Army Research Laboratory, Adelphi, MD (US)

(72) Inventors: Peter Gadfort, Washington, DC (US); Oluseyi Ayorinde, Marina Del Rey, CA (US)

(21) Appl. No.: 16/999,257

(22) Filed: Aug. 21, 2020

(51) Int. Cl. G06N 3/063; G06N 3/04; G06N 3/08

(52) U.S. Cl. CPC G06N 3/063; G06N 3/08; G06N 3/0445

(57) ABSTRACT

A field programmable neural array is an integrated circuit designed for artificial intelligence applications at the tactical computing edge. This platform combines a domain specific accelerator for AI with a reconfigurable interconnect to permit a deep neural network to be mapped into the field programmable neural array. The field programmable neural array includes domain specific accelerators that perform inference tasks with higher computing efficiency than central processing units and graphics processing units, approaching that of application-specific integrated circuits designed specifically for AI applications, and a reconfigurable interconnect providing the flexibility and connectivity of a field programmable gate array with lower power consumption.

### GOVERNMENT INTEREST

The embodiments herein may be manufactured, used, and/or licensed by or for the United States Government without the payment of royalties of thereon.

### BACKGROUND

### Technical Field

The invention relates to new and useful improvements in computing systems. More specifically it relates to scalable, multi-cast communications for artificial intelligence machine learning applications with specific accelerator interconnect circuitry, re-programmability and local block memory.

### Description of the Related Art

To date most research has focused on building AI hardware for datacenter and cell phones supporting a narrow class of neural networks and generally achieve high efficiencies by batching the data together.

Most artificial neural systems in commercial use our modeled on von Neumann computers. This allows the processing algorithms to be easily changed and different network structures implemented, but at a cost of slow execution rates for even the most modestly sized network. As a consequence some parallel structure supporting neural networks have been developed in which the processing elements emulate the operation of neurons to the extent required by the system model may deviate from present knowledge of actual neurons functioning to suit the application.

Conventional approaches to efficiently implementing tape neural networks on-chip result in relatively rigid implementations; while these approaches achieve high computational efficiencies they do not permit system engineers to change the fundamental architecture once the hardware has been deployed. As a result, new network structures and varying sizes of DNN as require development and fabrication of new hardware which is costly and not compatible with rapid deployment schedules. Field programmable gate array implementations of DNN SP bar also possible, and even though they allow for greater flexibility, they are not able to reach the efficiencies required for military age computing applications. There is a need for a solution that includes a field programmable neural array that can target of computational efficiency of 200 GOPs/W.

The accuracy of the nonlinear digital simulation of a neural network depends upon the precision of the weights, neural values, product, some of the product, and activity values, and the size of the time step utilized for simulation. The precision required for a particular simulation is problem dependent. The time step size can be treated as a multiplication factor incorporated into the activation function. The neurons and the network may all possess the same functions but this is not required.

Neurons modeled on a neural processor may be simulated in the direct or a virtual implementation. In a direct method each neuron has a physical processing element available which we operate simultaneously in parallel with the other neuron physical element active in the system. In a virtual implementation multiple neurons are assigned to individual hardware processing elements, which requires a data processing element processing be shared across as a virtual neurons. The performance of the debt work will be greater under the direct approach but most prior artificial neural and systems utilized the virtual neuron concept due to architecture and technology limitations.

Many military systems have extremely stringent size, weight, power, and cost constraints, and are therefore, especially sensitive to increases in the total power load; thus, they require low-power additions to their platforms. Focusing on the most common platforms we think tabulate power required for different DNN set speech recognition and radar identification networks based on the operations count from the Netscope CNN analyzer and efficiency from each research. Additionally, but close these energy efficiencies only account for the Compute efficiency of the platform the power cost of assessing all the required parameters is included as well as by assuming a 20 PJ/bit and 16 bit words for each parameter except for the application specific integrated circuit which uses 4-bit words. Graphics processing units and field programmable gate arrays (FPGA) require too much power to make them practical for most edge computation applications as well as any of the extremely large networks like You-Only-Look-Once (YOLO). Because the field programmable neural array is streaming the data through the pipeline the operation of the field programmable neural array can be slowed stance such that the throughput is the same as that of other platforms. The latency of the results will be dependent on the depth of the network; therefore two power numbers are reported for the field programmable neural array one with low similar latency as the other platforms and one with higher latency labeled as low and high respectively. Thus there is in need for applications where higher latency is tolerable a field programmable neural array would have a negligible impact to the soldier mission. A field programmable neural array (FPNA) would reduce the mission length by a few hours in some cases while these cases are not likely to be deployed on the soldier the AI deployed on the soldier would be better tailored to the mission and the supported hardware.

Over the last few years advances in programmable logic devices have resulted in the commercialization of Field-Programmable gate arrays which are able to support relatively large numbers of programmable logic elements on a single chip. The size and speed of those circuits improve at the same rate as microprocessors size and speed since they rely on the same technology. Distributed computing was thought of as one solution however it yields poor speed improvement per processor added due to communication cost. A graphics processing unit base to accelerate are was a another potential solution but it could only accelerate he limited spectrum of machine-learning algorithms due to its special hardware structure optimized for graphics applications. Memory access bandwidth, communication costs, flexibility and regularity of parallelism remain bottlenecks for these solutions. Furthermore despite their recognized performances, the high cost of developing application specific integrated circuits has hampered such hardware neural network computing devices from seeing significant applications.

Further aspects and advantages of this invention will become apparent from the detailed description which follows.

### SUMMARY

In view of the foregoing, an embodiment herein provides a device comprising a field programmable neural array is an integrated circuit designed for artificial intelligence applications at the tactical computing edge. This platform combine's domain specific accelerator is for AI (artificial intelligence) with a reconfigurable interconnect to permit an ED neural network to be mapped into the field programmable neural array. The field programmable neural array includes domain specific accelerators that perform inference tasks with higher computing efficiency than central processing units and graphics processing units, approaching that of application-specific integrated circuits designed specifically for AI applications, and a reconfigurable interconnect providing the flexibility and connectivity of a field programmable gate array. Chip bridge circuits at the periphery of the field programmable neural array allow the chips to be tiled together to arbitrarily large sizes in order to scale with larger computing problems. The field programmable neural array includes all of the data required for the machine-learning algorithms on-chip, allowing for the real-time operation required by many edge applications.

The FPNA is capable of implementing AI markup language algorithms and of being reprogrammed field programmable allowing a single device to be deployed in many applications this is critical in minimizing the cost of deploying new algorithms to the warfighter while enabling AI markup language on the warfighter without a substantial increase in power demand.

### BRIEF DESCRIPTION OF THE DRAWINGS

The embodiments herein will be better understood from the following detailed description with reference to the drawings, in which:

FIG. 1 is a diagram showing relative computing efficiency for artificial intelligence platforms.

FIG. 2 is a diagram of examples of the fabric of a field programmable neural array (FPNA).

FIG. 3 is a diagram depicting the movement of data through the field programmable neural array (FPNA) fabric.

FIG. 4 is a diagram depicting the neuron and related synapse internal structure.

FIG. 5 is a diagram depicting paths for signal processing and power transmission.

FIG. 6 is a diagram depicting neuron place and route program flow.

FIG. 7 is a diagram depicting placement.

FIG. 8 is a diagram depicting routing schedules within a field programmable network array (FPNA).

FIG. 9 is a diagram depicting network structure for speech recognition.

FIG. 10 is a diagram depicting a 3×2 grid of field programmable network array (FPNA) chips.

### DETAILED DESCRIPTION

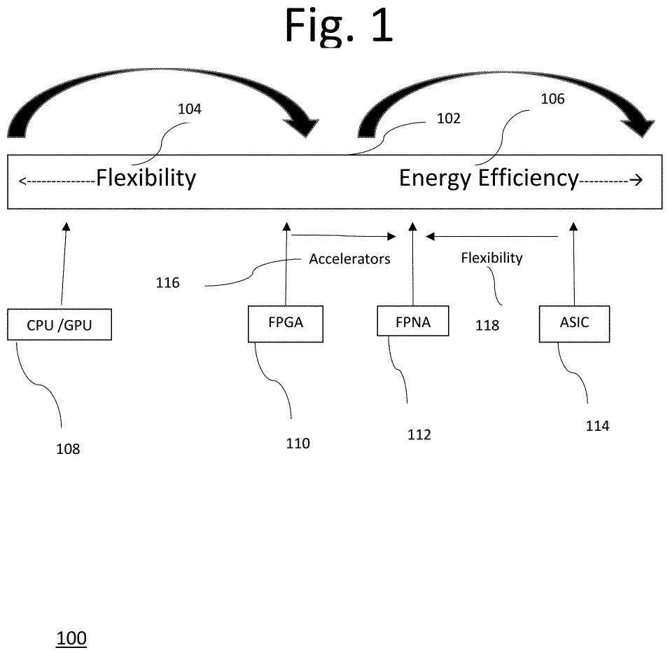

The field programmable neural array (hereinafter referred to as FPNA) is designed to meet the challenge of efficiency and flexibility for artificial intelligence (AI) applications at the tactical computing edge. The present invention overcomes the obstacles by borrowing interconnect fabrics from field programmable gate arrays (FPGA) (also referred to here as synapses) and implementing dedicated accelerators (neurons) to perform the required mathematics, resulting in an FPNA architecture. By using a programmable fabric, composite neurons can be created in the hardware to implement more complex functions like long and short term memory cells or cells with larger input spaces than would be physically possible with the individual neuron. The present invention will open up new computing opportunities by providing entities such as the military with a cost-effective, energy efficient machine learning platform they can be deployed to the warfighter. Additionally, the FPNA can be configured to operate on four, eight, and 16 bit data using resource sharing such that additional software is not needed for different bit-widths, and additional efficiency can be achieved when lowering the bit-width. For example, operating on eight bit words allows the FPNA to perform two operations per clock cycle and operating on four bit words increases that up to four operations per second without increasing the power usage. FIG. 1 shows the energy efficiency of different computing platforms 100, flexibility 104 and energy efficiency 106 are on bar 102 while popular platforms CPU/GPU 108, FPGA 110, ASIC 114, and the present invention FPNA 112 are shown in relation to 102. Accelerators 116 and flexibility arrows 118 are also indicated.

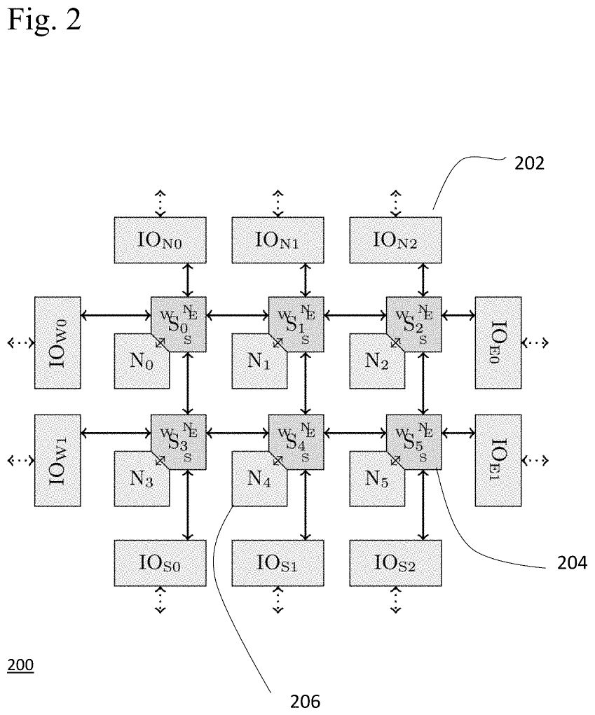

FIG. 2 shows an example of the FPNA fabric 200, illustrating how the neurons and synapses are connected to each other and how the synapses are tied both together and to off-chip communications. The input output neurons 202 run along the outer edge of the fabric 200, while synapses 204 and other layer neurons 206 are on the inside of the input output neurons 202.

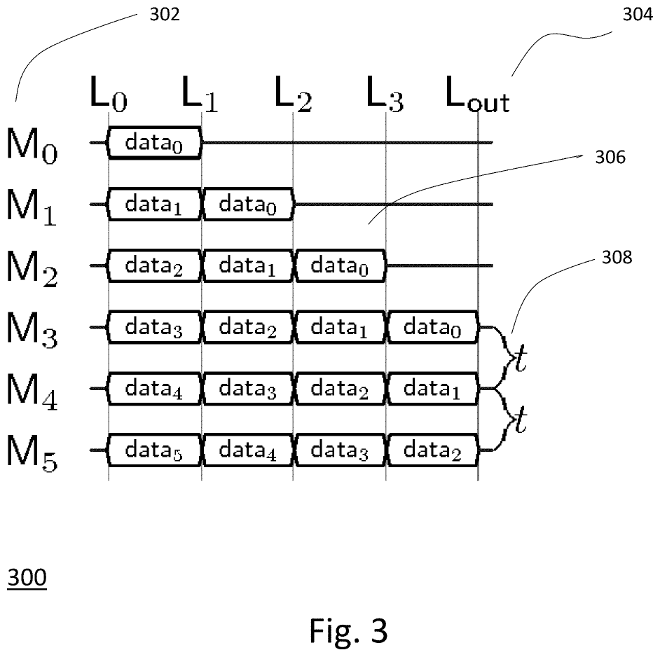

FIG. 3 is a diagram depicting how the FPNA moves data around on the chip as likened to a pipeline. The pipeline 300 is data streams 306 bounded by movements 302 and layers 304. T 308 is a time component related to the various data stream movements. Here, each step of the data movement is described by M_{0 . . . 5} and each layer of neurons is described by L_{0 . . . 3 out}. By pipelining the FPNA, one can keep the neurons full of information and better utilize the total functionality of the chip. The FPNA exclusively uses on-chip memories to store the weights and biases in order to eliminate costly off-chip memory accesses. This is a significant departure from other solutions that rely heavily on and external memory to provide the weights and biases.

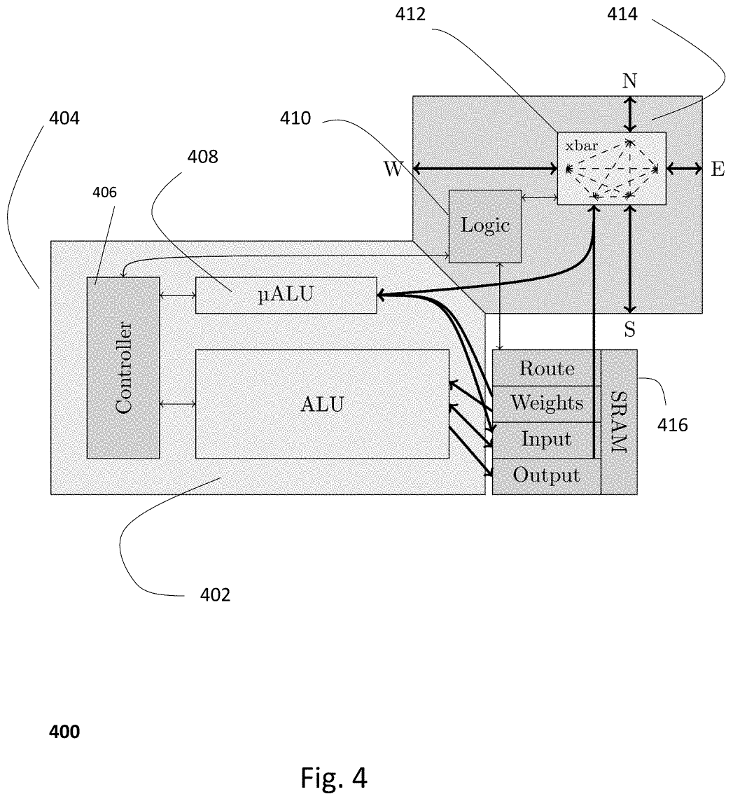

FIG. 4 is a diagram depicting the neuron and related synapse internal structure 400. The processor element 404 contains a controller 406, an ALU 402, and a uALU 408. The processor element 404 is in communication with the neuron synapse 416 and neuron 414 containing the logic 410 and xbar 412 elements. Each neuron synapse 416 pair shares a SRAM, which is programmed into four different regions: routing data, weights and bias data, input data, and output data. This configuration which allows the FPNA 400 to change how the different sections of the memory are allocated. For example a convolutional layer may not require as much weights and bias memory compared to a fully connected layer and by allowing different allocations of the FPNA 400 can better utilize the space available.

The following discussion focuses on two structures of the FPNA: neurons 400 which perform the necessary mathematics to compute each layer of a DNN and synapses 416 which support the neurons 400 and move data between them. The following section describes the programming of each neuron 400 and synapse 416 to be able to perform machine learning inferencing tasks.

The neuron 400 is the domain specific computational engine of the FPNA the performs all the required mathematics and data organization necessary to complete the computation of an AI interface; however, the neuron is not limited to AI interface, but can also be special built for signal processing and other domains. Fundamentally of the neuron 400 is only capable of doing a couple of mathematical operations, determined by the domain of the specific application, for the case of neural networking the functions are: addition, subtraction, comparison, and multiplication. These are the needed functions to be able to build different layers from a neural network: convolutional, max pooling, and fully connected. Keeping the neuron 400 functions simple allows the neuron to stay relatively small and allow the programming tools to decompose the mathematics to fit inside the neurons.

The following is the operation of the neuron, the μALU 408, which is part of the input buffer receives the data from the synapse 416 and performs simple operations on the data, such as addition, subtraction, max, etc.,. All functions that are relatively fast and can be completed in a single clock cycle and is stored into the input memory. This is useful for combining results from different neurons 400.

Once the synapse 416 delivers data to the neuron 400, the neuron 400 will prevent the synapse 416 from writing new results to the input memory and the primary ALU 402 takes over. This is designed to perform more complex tasks, such as matrix multiplication vector multiplication, convolutions, and Max pooling. These tests generally take multiple clock cycles to build a single result or multiple inputs are required for multiple outputs, such as in the case of convolutions, therefore these tasks are handled here.

The neuron 400 stores the results in an output buffer ready for the synapse 416 to transmit the results to the next neurons. After collection of the results, the input memory is scrubbed of data and reset to get ready for new data; the neuron 400 will announce to the synapse 416 it is ready to receive new data and the old data can be transmitted. While the neuron 400 is dormant, the clock is turned off to most of the circuit to save as much power as possible.

The synapse 416 is the reconfigurable interconnect block in the FPNA and is responsible for routing the data from a neuron 400 to other neurons. The connectivity of computational blocks varies widely in neural network implementations, ranging from relatively sparse connectivity in convolutional neural networks (CNN) to the dense connectivity of fully-connected layers used for classification. As a result, the synapse 416 is designed to support varying levels of connectivity efficiency. This architecture is similar to a network on-chip (NoC) however, by recognizing that data always moves between the same set of neurons 400 at any given time, the inter-block traffic can be scheduled to avoid collisions and known ahead of time. This allows the synapses in the FPNA to be far less complex than routing nodes in a network on-chip by removing arbitration and buffering circuitry altogether and replacing them with pre-determined synapse configurations stored in the routing configuration table, located in the shared memory.

The development of the routing configurations includes additional control signals (not shown in FIG. 4) are used to maintain synchronization throughout the network so that the synapses do not move on to different configurations in the routing table before data finishes traversing the interconnect the connectivity of the synapses. This is only limited by the memory allocation in the tile for communication and as a result the synapses can communicate with each other and other computing resources that are far away in the system.

The synapse utilizes three control signals (not shown), ready, active, and valid to coordinate the movement of data, 16 bits, with neighboring synapses, neurons and chip bridges and to ensure that all synapses process and pass the data successfully by avoiding data collisions in synapses, without the need for arbitration.

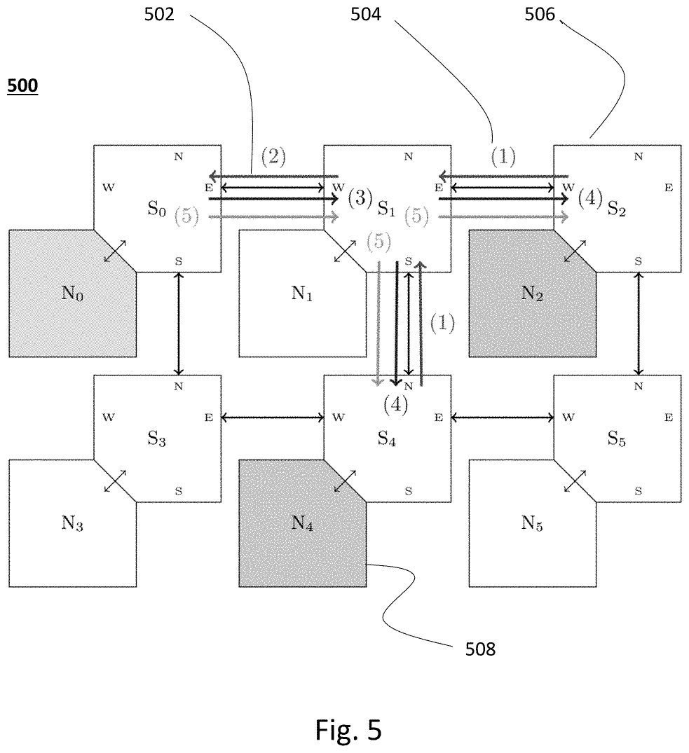

FIG. 5 is a diagram depicting paths for signal processing and power transmission 500. The functionality of control signals 502 is illustrated in FIG. 5 and explains that once the S2 and S4 are configured they are each ready to send-tour to S1 once S1 504 is configured, and ready is high from both S2 506 and S4 ready tort S0 is set to one. Once the source receives a high ready signal, active shown as a blue arrow, goes high Ford the data destination, from S zero to S1. S1 sets active high port both S2 and S4. Valid signals from S is zero to S1 and from S2 to S4 go high as data streams from S0 to S2 and S4. Valid is high when data are actually being passed between the synapses, and goes low intermittently to mask the loading and clearing of data from the buses. 508 illustrates the communication between neuron N4 and the synapse S4.

The use of these signals creates an asynchronous handshake between the synapses resulting in a globally asynchronous, locally synchronous architecture for the FPNA this allows the synapses to operate properly with the varying delays of data propagation throughout the interconnect. In addition to reducing the size of the routing logic compared to a network on-chip, the synapse reduces the size of the packet being sent from neuron to neuron. When data is transmitted over a network on-chip (NoC), the first packet generally contains information about the data being transmitted. For example, in the OpenPiton network on-chip (NoC), the first packet describes information about the destination of the information. The synapse is designed such that only data is sent from neuron to neuron during inference, removing the need for transmitting information to direct the data through the interconnect.

Many network on chips like OpenPiton, only support point-to-point communication. The present invention FPNA interconnect, instead, performs multi cast communication, and allows the FPNA spreads logic to implement each layer across many neurons, thus, connections between layers of the FPNA will come from multiple neurons and terminate at multiple different neurons. If there are N neurons in one layer and M neurons in the next layer, a network that only supports point-to-point communication would require and M transmissions just for the communication with that layer the synapse interconnect used in the FPNA could do all of the communication between the layers in parallel but due to the fact that each of the N neurons is in the first layer are communicating with the same M neurons in the second layer it would require ˜N transmissions.

One important feature of the FPNA is the extensibility of the network beyond one single chip, allowing a collection of FPNAs to implement larger algorithms. To do this efficiently, the FPNA contains a chip bridge circuit. The chip bridge maintains the same control signaling that the synapses in the FPNA expect and as a result allows the synapses to interface with the chip boundaries without any change in functionality.

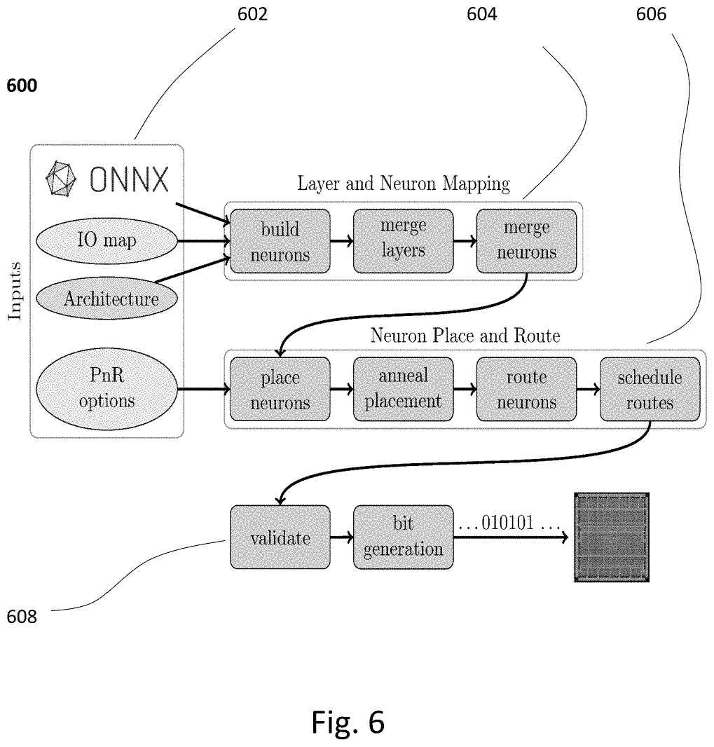

For the FPNA to be useful in it must be programmed with the desired trained neural network. To make sure this step is easy as possible for the users of the FPNA, the authors have developed the neuron place and route program flow illustrated in FIG. 6.

FIG. 6 is a diagram depicting neuron place and route program flow. This flow 600 is modeled after Verilog-to-Route (VTR) open source synthesis tool for FPGA. Inputs are shown in 602, while layer and neuron mapping are depicted in 604. Neuron place and route (NPR) are shown in 606 and finally validation occurs at 608. However instead of FPNA synthesis, place, and route, NPR 606 does mapping, placing, routing, and scheduling. The input 602 to this flow is a trained neural network in the form of an open neural network exchange file, along with how the inputs and outputs of the network need to be mapped to the FPNA, and an architecture file which describes the physical properties of the FPNA following subsections will describe the flow in detail.

The first step in programming the FPNA is to build a candidate mapping for the input network one can accomplish this by building specific neurons for each of the layer types. To build a convolutional layer, for example, break the input feature map into smaller manageable pieces, those mapped separately into different neurons and the results are then collected in the next layer. The second step is to attempt to merge any layers that can be merged, for example when a rectified linear unit (ReLU) layer is followed by Max pooling, or vice versa, one can combine the layers into a single layer of Max pooling with an additional input of the Max of zero. This correctly generated the right result while eliminating additional, redundant neurons. Additionally it is possible to perform merges when inning the bias to the fully connected layer or convolutional layers. These “adds” could be merged back into the layer larger neurons, freeing up resources. Finally all of the generated neurons are evaluated to those that share inputs or outputs and have available memory left. They will be merged to fill up a neuron and ensure generation of the least number of neurons. These steps combined ensure that the least number of neurons are used to implement a given network, however, the tool currently does not consider throughput requirements so is possible the merging will assign much more work to key neurons reducing the throughput of the system.

Once the network is mapped to neurons, the neuron place route (NPR) flow places these neurons with in the physical limits of the FPNA chip. And Pilar currently supports three placement variations, random placement and two versions of linear placement, one that fills each row first, and one that fills each column first. The authors have found that, of these three, the random placement produces the best results. From here, the creation of a cost function is based on the total routing distance between the neurons, and the FPNA is replaced by swapping neuron locations in a direction that reduces the cost function. Future versions of NPR will improve on this placement algorithm by using more sophisticated cost functions i.e. Heavily penalizing cross-chip communication between neurons and annealing steps. After placement of the neurons the routing step commences, where the configurations for the synapses are set to connect the neurons together. Each route for the FPNA from neuron to neuron goes through one or more synapses. Configuration of each synapse in a given path is static, where one input and one or more outputs are opened, allowing the streaming of data from one neuron to another. If the completion of the streaming between the neurons the synapses reconfigure to a different configuration with the new outputs and a new input and the streaming is allowed again. In the FPNA each of these configurations are called schedules. Neuron place route (NPR) attempts to parallel highs these schedules as much as possible, if paths do not share routing resources, then configuring many parallel paths during the same schedule is possible. These configurations also allow data to flow from a single neuron to multiple destinations, and the logic in the synapse allows for different destinations to ingest different parts of the data stream. The current routing implementation in the NPR is X first then routing, future versions of NPR will aim to use more sophisticated routing algorithms and allow for smarter routing combining shared routes for more efficiency, etc.

The LeNet network which is used for numerical image classification is small enough to fit on one chip the network includes one convolutional layer, one layer of REL youth functions one layer of Max pooling, and one fully connected layer. The NPR programming tool flow packs the network into 25 neurons in the FPNA. Of the 64 synapses in the FPNA, LeNet uses on average of 10:50 synapses in each schedule, at 24 synapses.

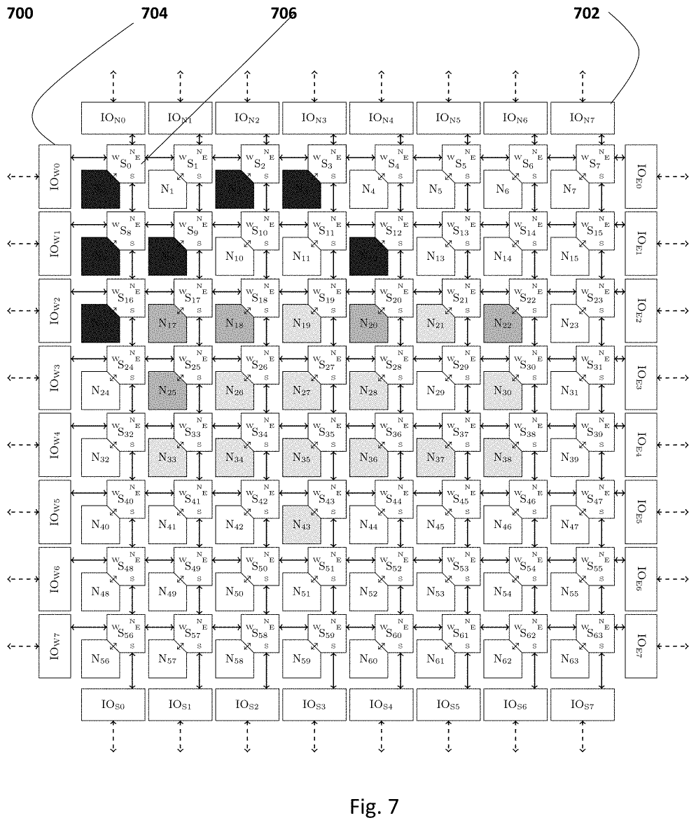

FIG. 7 is a diagram depicting placement of the LeNet Network on an FPNA. This is a full FPNA 700 implementation of the LeNet Network. A simulation was conducted and in this simulation, data was provided to the input of the FPNA every 1.197 milliseconds which corresponds to about 835 inferences per second this is the fastest that the FPNA can provide inference results with that given configuration and is much faster than many image classification rates. Here input for power is shown as 704 while other input is shown as 702 and synapse are shown as 706.

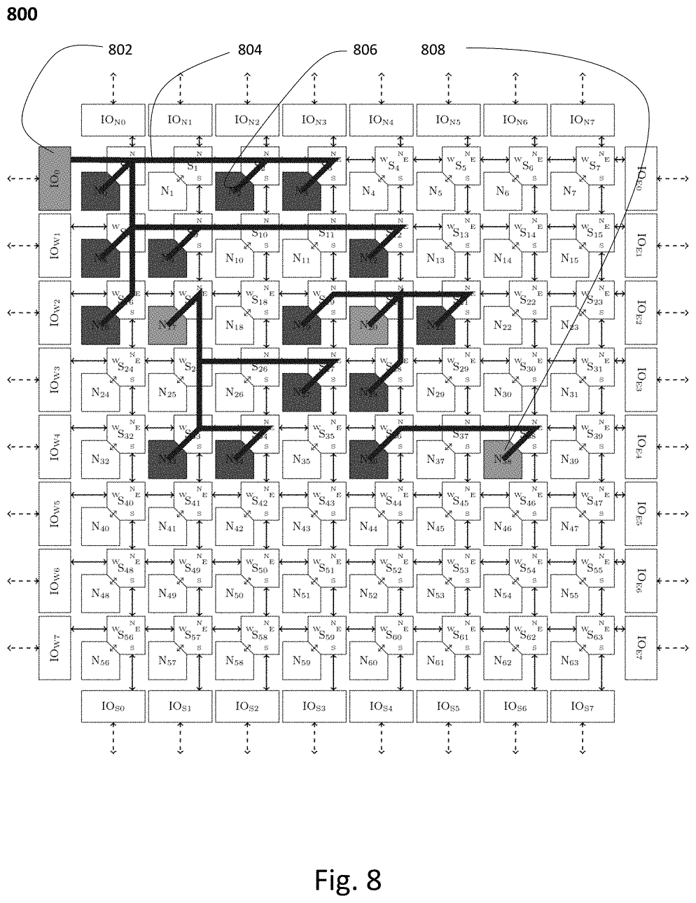

FIG. 8 is a diagram depicting routing schedules within a field programmable network array (FPNA) 800. The FPNA 800 consumes 13.6 mill watts which corresponds to an efficiency of 22.4 GOPs per watt this efficiency is due to multiple factors, it has been shown that bit width can be reduced from integer precision 16 bits down to 8 or even 4 bits without substantial loss of accuracy. Inventors foresee an expected efficiency of over 200 GOPs with 8-bit precision and over 400 GOPs with 4-bit precision. Inventors believe this is easily achievable these are orders of magnitude more efficient than CPUs, GPA use and FPGAs and the present invention now approaches ASIC like efficiency. In FIG. 8 input is shown as 802, 804 shows the routing inferences while 806 depicts a data linked neuron and finally 808 depicts two data linked neurons functioning as a pair.

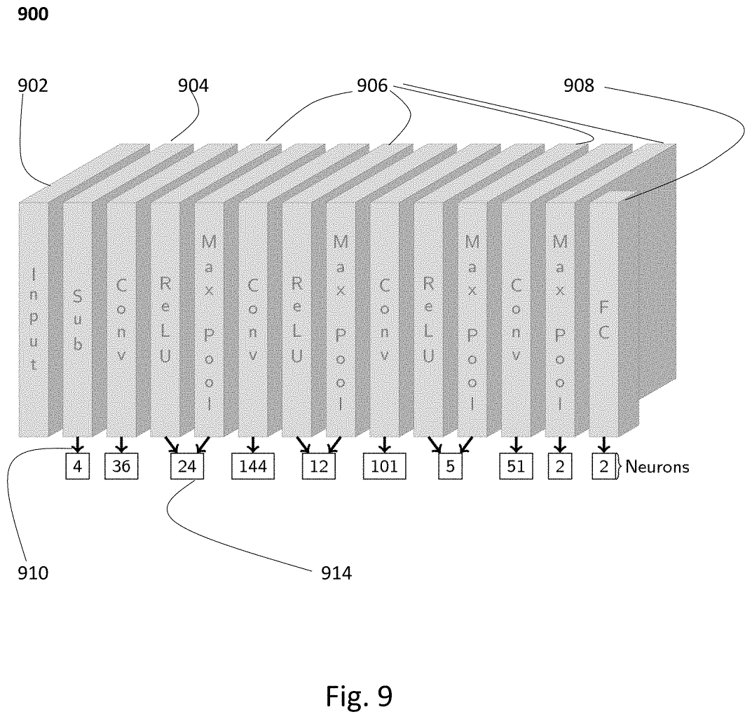

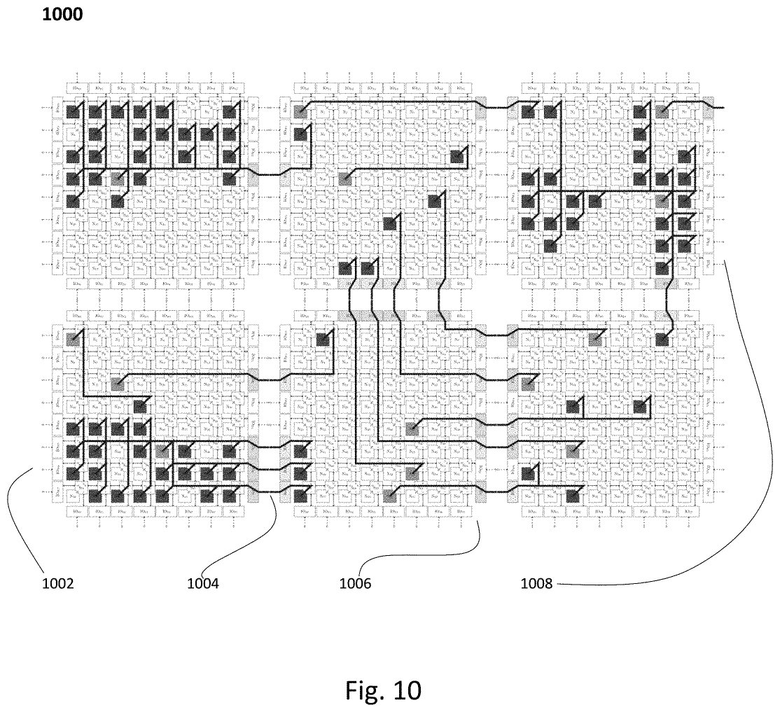

FIG. 9 is a diagram depicting network structure for speech recognition 900. The speech network 900 is based up on the tutorial from MathWorks with the normalization layers removed since this version of the FPNA does not support them. FIG. 9 shows the structure of the network below the network, including the input 902, sub 904, FC 908 and is mapping output of the NPR 910 and illustrating how many neurons 914 are required for each layer in the network. For example this shows how the ReLU and Max pooling layers 906 are combined and effectively saves 41 neurons over the entire network. This network requires a total of 381 neurons meaning implement this network is required to have six FPNA chips which will be configured as a three by two grade of FPNA chips as shown in FIG. 10.

FIG. 10 illustrates how the synapse bridges are utilized the two extend the FPNA System across the multiple chips 1000. Each FPNA 1002 is connected by physically 1004 other FPNA chips 1006 and 1008 respectively. This routing example is one of 69 schedules present in this output from NPR. In this schedule the green neurons are the source neurons and the red neurons are the destinations of the data from the green. Across the boundaries of the different FPNAs, through the bridges the data can flow from one FPNA to another and in a few cases through multiple bridges to arrive at their intended destination.

The present invention represents new architectural innovation the field programmable neural array for AI at the tactical edge. This innovation provides the required energy efficiency and flexibility to allow for the deployment of AI for a myriad of military applications.

What is claimed is:

1. A field programmable neural array network system comprising;
a field programmable neural network architecture having programmable fabric in communication with and having a plurality of composite neuron pairs performing computations associated with a neural network machine learning algorithm for artificial intelligence by coordinating the movement of data and having a plurality of synapses, a plurality of neurons and a plurality of chip bridges and ensuring that all of the synapses process and pass data successfully by avoiding data collisions it without the need for arbitration and creating globally asynchronous locally synchronous architecture for the field programmable neural network while reducing routing logic such that the synapse reduces a the size of the packet being sent from neuron to neuron, and including hardware logic to facilitate the movement of data wherein each neuron synapse pair shares an SRAM and further comprising a deep neural network on chip and having a domain specific accelerator and dynamic memory allocation.

2. The field programmable neural network system as recited in claim 1 wherein the neural network machine learning algorithm comprises performing operations on data such as addition, subtraction, and max pooling.

3. The field programmable neural array network system as recited in claim 1 wherein the synapse further acts to deliver data to the neuron.

4. The field programmable neural array network system as recited in claim 1 wherein the machine learning algorithms are artificial intelligence algorithms.

5. The field programmable neural array network system as recited in claim 1 where in the hardware logic of its specifically configured for artificial intelligence applications for military use.

6. The field programmable neural array network system as recited in claim 1 that further comprises a deep neural network that can change to a convolutional neural network and a recurrent neural network even after the hardware has been deployed.

7. The field programmable neural array network system as recited in claim 1 where in the hardware logic of the field programmable neural network further comprises a processing element to change from 16 bit words down to 4-bit words in order to increase efficiency and reduce power consumption.

8. The field programmable neural array network system as recited in claim 1 wherein the hardware logic of the neural network further comprises a processing element to slow down the stream of data in order to conform to other slower platforms that are in communication with the field programmable neural array.

9. The field programmable neural array network system as recited in claim 1 wherein the hardware logic includes two power modes, a low latency and a higher latency.

10. The field programmable neural array network system of claim one wherein the system can perform any range between 15 to 200 inferences per second.

11. The field programmable neural array network system as recited in claim 1 wherein the field programmable neural array is provided on a substrate.

12. The field programmable neural array Network System as recited in claim 1 further comprising an element for performing 2 to 4 operations per cycle based on bit width utilized.

13. The field programmable neural array network system as recited in claim 1 wherein each neural synapse pair shares an SRAM, said SRAM comprised of being programmed into a routing data region, a weights and bias data region, an input data region and an output data region whereby a dynamic memory architecture is created.

14. A field programmable neural array computing system comprising;
a host computing device for storing and processing artificial intelligence data;
a matrix of field programmable neural arrays provided on a substrate and configured to have a hardware logic performing computations associated with a field programmable neural array network artificial intelligence algorithm by receiving stream to data directly from the host computer device, the field programmable neural array including a plurality of layers for processing, a set of input and output layers, a ReLU layer, a max pooling layer, a convolution layer, and a fully connected layer, and a hardware element that performs computations within then neural network, an artificial intelligence algorithm, and that interface for connecting the field programmable neural array to the host computing device.

15. The method as recited in claim 14, wherein mapping input network comprises building a convolutional layer.

16. The method as recited in claim 14, further comprising merging layers ReLU layer is combined with max pooling layer and addition input layer.

17. The method as recited in claim 14, further comprising merging by adding the bias layer to a fully convolutional layer and communication layers.

18. The method as recited in claim 14 further comprising, sharing all inputs and outputs among the various layers.

19. The method as recited in claim 14 further comprising, managing resources to ensure that the least number of neurons are used to implement a given network.
